(19) United States
(12) Patent Application Publication
(10) Pub. No.: US 2021/0035583 A1
(43) Pub. Date: Feb. 4, 2021

(54) SMART DEVICE AND METHOD FOR CONTROLLING SAME

(71) Applicant: HUMAX CO., LTD., Yongin-si (KR)

(72) Inventors: Sungheum PARK, Gwangju-si (KR); Younghoon KIM, Siheung-si (KR); Seungwon KANG, Yongin-si (KR)

(73) Assignee: HUMAX CO., LTD.

(21) Appl. No.: 17/075,416

(22) Filed: Oct. 20, 2020

Related U.S. Application Data
(63) Continuation of application No. PCT/KR2018/014225, filed on Nov. 19, 2018.

(30) Foreign Application Priority Data
Jul. 27, 2018 (KR) 10-2018-0087682

(51) Int. Cl. G10L 15/22; G06F 9/451

(52) U.S. Cl. CPC G10L 15/22; G06F 9/453; G10L 2015/221; G10L 2015/223; G10L 2015/225

(57) ABSTRACT

The present disclosure is related to a method for controlling a smart device configured to obtain a voice command and output various feedbacks corresponding to the voice command, comprising: receiving a first voice including a first voice command and uttered by a user; obtaining a first contents which corresponds to the first voice command; outputting a display-back displaying a first area including a part of the plurality objects of the first contents; receiving a second voice including a second voice command and uttered by the user; when the first object is included in the first area, performing the first operation; and when the first object is not included in the first area, performing a second operation.

### CROSS-REFERENCE TO RELATED APPLICATIONS

This application is a continuation of pending PCT International Application No. PCT/KR2018/014225, which was filed Nov. 19, 2018, and which claims priority to Korean Patent Application No. 10-2018-0087682 filed with the Korean Intellectual Property Office on Jul. 27, 2018. The disclosures of the above patent applications are incorporated herein by reference in their entirety.

### TECHNICAL FIELD

The present disclosure relates to a smart device and a control method thereof, and more particularly, to a smart device configured to acquire a voice command and output a variety of feedback corresponding to the voice command and a control method thereof.

### BACKGROUND ART

The development and utilization of speech recognition technology have been greatly increased in the smart home field thanks to the proliferation of the Internet of Things (IoT) technology. As one core device, smart speakers using artificial intelligence (AI), which can carry out commands and communicate via speech, are becoming widely used. Looking at the global market, since Amazon released the first speech recognition speaker Echo in 2014, major information technology (IT) companies such as Google and Apple released or will release speakers equipped with their own software, and the domestic market is also showing fierce competition.

Generally, such a smart speaker equipped with an “artificial intelligence assistant” function refers to a smart device configured to receive a voice command and output feedback corresponding to the command in the form of audio. Smart speakers have improved user convenience in that they can be controlled by speech compared to buttons or touch interfaces of traditional smart devices but have been criticized in that available information is limited and information acquisition by users is inefficient because they provide feedback in the form of audio.

In order to overcome these weak points, smart speakers are gradually changing to smart displays, which are equipped with displays and can provide feedback in the form of video as well as in the form of audio. Along with the change, there is a need to develop an enhanced smart device that actively contributes to the construction of augmented reality and provides a better user experience.

### DISCLOSURE

### Technical Problem

The present disclosure is directed to providing a smart device that acquires a voice command and performs feedback.

The present disclosure is directed to providing a method of controlling a smart device that acquires a voice command and performs feedback.

The present disclosure is directed to providing a smart device that provides a voice interface.

The present disclosure is directed to providing a smart device that acquires a voice command and provides user content corresponding to the voice command.

### Technical Solution

With respect to an aspect of present disclosure, a method for controlling a smart device configured to obtain a voice command and output various feedbacks corresponding to the voice command can be provided.

A method for controlling a smart device may include, receiving a first voice including a first voice command and uttered by a user; obtaining a first contents which corresponds to the first voice command, wherein, the first contents include a plurality of selectable objects and each object included in the plurality of objects includes identifier assigned to the objects respectively; outputting a display-back displaying a first area including a part of the plurality objects of the first contents; receiving a second voice including a second voice command and uttered by the user, wherein the second voice command includes a first identifier which corresponds to a first object included in the plurality of objects and requests performing a first operation related to the first object; wherein when the first object is included in the first area, performing the first operation; and wherein when the first object is not included in the first area, performing a second operation requesting confirmation of performing of the first operation related to the first object and the first object, to the user.

With respect to an aspect of present disclosure, a smart device configured to obtain a voice command and output various feedbacks corresponding to the voice command, wherein, the feedbacks include a display-back and a talk-back, can be provided.

A smart device may include, a microphone module configured to obtain the voice command; a video output module configured to output the display-back; a speaker module configured to output the talk-back; and a control unit configured to, receive a first voice including a first voice command and uttered by a user via the microphone module, receive a second voice including a second voice command and uttered by a user via the microphone module, wherein, the second voice command includes a first identifier which corresponds to a first object included in the plurality of objects. requests a first operation related to the first object, via the microphone module, performs the first operation when the first object is included in the first area, and performs a second operation requesting confirmation of performing of the first operation related to the first object and the first object, to the user, when the first object is not included in the first area.

Technical solutions of the present disclosure are not limited to those mentioned above, and other unmentioned technical solutions should be clearly understood by one of ordinary skill in the art to which the present disclosure pertains from the present specification and the accompanying drawings.

### Advantageous Effects

According to the present disclosure, it is possible to provide a smart projector that outputs user-oriented feedback.

According to the present disclosure, it is possible to provide a smart projector that outputs a display-back in consideration of a user's location.

According to the present disclosure, it is possible to provide a smart device that outputs a talk-back in consideration of a user's location.

Advantageous effects of the present disclosure are not limited to the aforementioned effects, and other advantageous effects that are not described herein will be clearly understood by those skilled in the art from the following description and the accompanying drawings.

### DESCRIPTION OF DRAWINGS

FIG. 1 shows a block diagram illustrating a smart device according to an embodiment of the present disclosure.

FIG. 2 shows a change in state of a smart device according to an embodiment of the present disclosure.

FIG. 3 shows a smart display according to an embodiment of the present disclosure.

FIG. 4 shows a smart projector according to an embodiment of the present disclosure.

FIG. 5 shows a smart projector according to an embodiment of the present disclosure.

FIG. 6 shows a smart projector according to an embodiment of the present disclosure.

FIG. 7 shows a smart projector according to an embodiment of the present disclosure.

FIG. 8 is a diagram illustrating user content according to an embodiment of the present disclosure.

FIG. 9 is a diagram illustrating user content according to an embodiment of the present disclosure.

FIG. 10 is a diagram illustrating the control of a display screen of a smart device according to an embodiment of the present disclosure.

FIG. 11 is a diagram illustrating the control of a display screen of a smart device according to an embodiment of the present disclosure.

FIG. 12 is a diagram illustrating a connection operation according to an embodiment of the present disclosure.

FIG. 13 is a diagram illustrating a connection operation according to an embodiment of the present disclosure.

FIG. 14 is a diagram illustrating a connection operation according to an embodiment of the present disclosure.

FIG. 15 is a diagram illustrating a connection operation according to an embodiment of the present disclosure.

FIG. 16 is a diagram illustrating a preliminary selection according to an embodiment of the present disclosure.

FIG. 17 is a diagram illustrating a connection operation according to an embodiment of the present disclosure.

FIG. 18 is a diagram illustrating the operation of a smart projector according to an embodiment of the present disclosure.

FIG. 19 is a diagram illustrating the operation of a smart projector according to an embodiment of the present disclosure.

FIG. 20 is a diagram illustrating the operation of a smart projector according to an embodiment of the present disclosure.

FIG. 21 is a flowchart illustrating a method of controlling a smart device according to an embodiment of the present disclosure.

FIG. 22 is a diagram illustrating a method of controlling a smart device according to an embodiment of the present disclosure.

FIG. 23 is a diagram illustrating a method of controlling a smart device according to an embodiment of the present disclosure.

FIG. 24 is a diagram illustrating a method of controlling a smart device according to an embodiment of the present disclosure.

FIG. 25 is a diagram illustrating a method of controlling a smart device according to an embodiment of the present disclosure.

FIG. 26 is a diagram illustrating a method of controlling a smart device according to an embodiment of the present disclosure.

FIG. 27 is a diagram illustrating a method of controlling a smart device according to an embodiment of the present disclosure.

### MODE FOR CARRYING OUT THE INVENTION

The above objects, features, and advantages of the present disclosure will become more apparent from the following detailed description taken in conjunction with the accompanying drawings. Since the present disclosure may be variously modified and have several exemplary embodiments, specific embodiments will be shown in the accompanying drawings and described in detail.

In the figures, the thickness of layers and regions is exaggerated for clarity. Also, when it is mentioned that an element or layer is “on” another element or layer, the element or layer may be formed directly on another element or layer, or a third element or layer may be interposed therebetween. Like reference numerals refer to like elements throughout the specification. Further, like reference numerals will be used to designate like elements within the same scope shown in the drawings of the embodiments.

Detailed descriptions about well-known functions or configurations associated with the present disclosure will be ruled out in order not to unnecessarily obscure subject matters of the present disclosure. It should also be noted that, although ordinal numbers (such as first and second) are used in the following description, they are used only to distinguish similar elements.

The suffixes “module” and “unit” for elements used in the following description are given or used interchangeably only for facilitation of preparing this specification, and thus they are not assigned a specific meaning or function.

1. Smart Device

1.1 Overview

A smart device according to an embodiment of the present disclosure will be described below.

The smart device according to an embodiment of the present disclosure can provide a variety of information to a user by receiving various forms of commands from the user and outputting feedback in the form of a speech or a picture in response to the commands. As an example, the smart device may respond to a user's voice command by receiving the user's utterance through a microphone module to acquire the voice command and outputting feedback such as a talk-back or a display-back.

An example of the smart device may include a smart projector. Here, the smart projector may be a device provided in the form of a projector installed in a conventional smart speaker. In addition, examples of the smart vehicle may include smart speakers, smart projectors, smart TVs, and the like. However, the smart device described herein is not limited to the above-described examples, and it is appreciated that various devices capable of outputting a speech and/or a picture may be used as the smart device described herein.

1.2 Configuration

The smart device may include at least one module for performing various functions. The smart device may use the at least one module to acquire a voice including a voice command or output feedback corresponding to the voice command. The types and functions of modules will be described below.

The smart device may include a microphone module configured to receive a speech signal. The microphone module may include a plurality of microphones.

The smart device may include a speaker module configured to output a talk-back. The speaker module may include a plurality of speakers.

The smart device may include a display module including a display configured to output a picture or an image. The display module may include a touch sensor.

The display module may be a projector module configured to emit light. The projector module may be an ultra-short-throw projector module. Herein, a smart device including the projector module is defined as a smart projector.

The smart device may include an optical sensor module configured to collect light. The smart device may acquire three-dimensional (3D) space information using the optical sensor module. The smart device may acquire user behavior information (e.g., gaze information) using the optical sensor module.

The optical sensor module may be a camera module configured to acquire a picture or an image. The camera module may be an infrared camera module or a visible light camera module.

The optical sensor module may be a depth sensor module. The depth sensor module may provide depth information of an object using a time of flight (TOF).

The smart device may include a communication unit. The smart device may communicate with a server using the communication unit. The smart device may communicate with an external apparatus using the communication unit.

The communication unit may perform wireless communication with an external apparatus. For example, the communication unit may perform wireless communication such as Wi-Fi and Bluetooth.

The communication unit may perform wired communication. For example, the communication unit may perform wired communication such as Universal Serial Bus (USB) and Ethernet.

The smart device may include a control unit. The control unit may control modules included in the smart device.

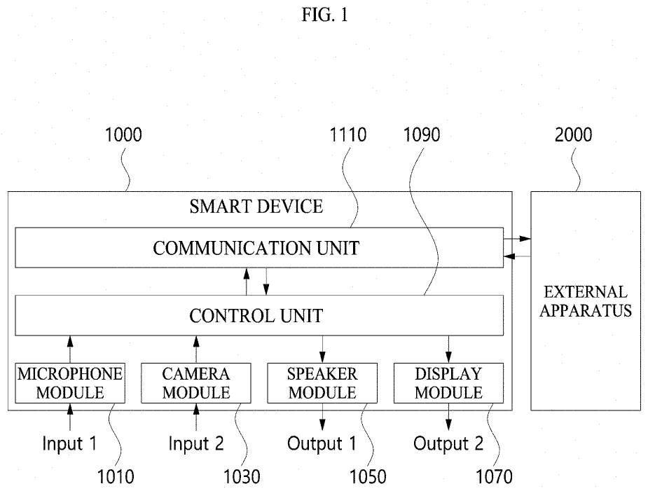

FIG. 1 shows a block diagram illustrating a smart device 1000 according to an embodiment of the present disclosure.

Referring to FIG. 1, the smart device 1000 according to an embodiment of the present disclosure may include a microphone module 1010, a camera module 1030, a speaker module 1050, a display module 1070, a control unit 1090, and a communication unit 1110.

The smart device 1000 may acquire a voice using the microphone module 1010 (Input 1). The smart device 1000 may acquire an image, a picture, or depth information using the camera module 1030 (Input 2). The smart device 1000 may output audio using the speaker module 1050 (Output 1). The smart device may output an image or a picture using the display module 1070 (Output 2).

The smart device may control each module using the control unit 1090. The smart device may process information acquired from each module using the control unit 1090.

The smart device may communicate with an external apparatus 2000 using the communication unit 1110. The smart device may transmit the acquired information to the external apparatus 2000 using the communication unit 1110. The external apparatus 2000 may be a separate server apparatus.

Meanwhile, FIG. 1 illustrates that the smart device includes the display module, but the smart device may be implemented as a smart projector having the projector module.

1.3 Command & Feedback

The smart device may receive a command from a user using the above-described modules. The smart device may acquire a signal including a user command. Also, the smart device may output a signal corresponding to the user command (hereinafter referred to as feedback).

The command acquired by the smart device and the feedback output by the smart device will be described below.

1.3.1 Command

The smart device may acquire a command or a signal including a command. As a representative example, the smart device may acquire a voice command or a voice including a voice command (or a speech signal). In addition, the command may include a voice command, a touch command, a gesture command, and the like. The command may be defined as a user behavior that requests a specific or random response from the smart device.

The smart device may provide an interface for acquiring a command from a user. The interface may include a voice interface for acquiring a voice command, a touch interface configured to acquire a touch command, and a gesture interface for acquiring a gesture command.

The smart device may acquire a voice. The smart device may acquire a voice using a microphone module. The smart device may acquire a voice uttered by a user. The smart device may acquire a voice including a voice command using the microphone module.

The smart device may forward an acquired voice command and/or a signal including a voice command to an external apparatus. The smart device may forward a voice command and/or a voice including a voice command to an external apparatus that provides information requested by the voice command. The smart device may transmit voice command data to an external apparatus. The external apparatus may be a server apparatus for communicating with at least one device.

The smart device may acquire a touch event including a touch command. The smart device may acquire a touch event occurring on a display using a touch sensor.

The smart device may acquire a gesture event including a gesture command. The smart device may acquire a gesture event using an optical sensor module and/or a camera module.

The following description assumes that the command is a voice command. However, the following description of the voice command may be similarly applied to a touch command or a gesture command.

1.3.2 Feedback

The smart device may acquire feedback data including information corresponding to the voice command and output feedback in the form of a speech or a picture.

The feedback may be understood as a signal including information corresponding to a command output in response to the device acquiring the command. The information corresponding to the command may include multimedia content.

The smart device may acquire feedback data corresponding to the command. The smart device may acquire a voice command and/or a voice including a voice command and acquire feedback data corresponding to the command.

The smart device may acquire the feedback data corresponding to the voice command from an external apparatus. The smart device may acquire the feedback data in response to the transmission of voice command data to an external apparatus.

The smart device may output feedback. The feedback may include voice feedback provided as speech or sound (hereinafter referred to as voice-back or a talk-back) or display feedback provided as a picture or image (hereinafter referred to as a display-back).

The smart device may output a talk-back. The smart device may acquire a voice command and/or a voice including a voice command and output a talk-back. The smart device may output a talk-back including information requested by the voice command. The smart device may output a talk-back using a speaker module. The talk-back may include audio content such as a song and a radio.

The smart device may output a display-back. The smart device may acquire a voice command and/or a voice including a voice command and output a display-back. The smart device may output a display-back including information requested by the voice command. The smart device may output a display-back using a display module or a projector module. The display-back may include video content such as TV programs, YouTube, and movies.

1.4 State of Device

The smart device may have various driving states. The data processing aspect of the smart device may be changed depending on the state of the smart device.

1.4.1 Off State

The smart device may be in an off state. In the off state, the smart device can minimize power consumption. In the off state, the smart device may not consume power. In the off state, the smart device may not collect or output signals.

In the off state, the smart device may be in a hibernation state.

1.4.2 Standby State

The smart device may have a standby state. In the standby state, the smart device may acquire or output signals.

In the standby state, the smart device may acquire a signal including a preliminary command for notifying a user about the occurrence of a command. A preliminary command or a signal including a preliminary command is predetermined and prestored in the smart device.

The smart device may acquire a voice including a preliminary command. The preliminary command included in the voice may be implemented in the form of a hot word or a wake-up word. In other words, the preliminary command may be predetermined as a command including a specific word.

The smart device may acquire a touch event or a gesture event including a preliminary command. The preliminary command included in the touch event may be any touch event or a touch event for a specific region. The preliminary command included in the gesture event may be a wake-up gesture corresponding to a specific sequence.

1.4.3 Listening State

The smart device may have a listening state. In the listening state, the smart device may acquire a signal including a voice command. The smart device may acquire a signal including the above-described preliminary command (e.g., a hot word) and may be changed to the listening state. The listening state may be triggered by the signal including the preliminary command.

In the listening state, the smart device may open a listening window. The smart device may acquire a hot word and open a listening window.

The smart device may open the listening window and collect a voice including a voice command. The smart device may open the listening window for a predetermined time period. The predetermined time period may be changed.

The smart device may close the listening window. The smart device may close the listening window and stop collecting the voice. The smart device may close the listening window and transmit the collected voice to an external apparatus. The smart device may transmit the collected voice to an external apparatus while the listening window is opened.

In the listening state, the smart device may acquire a preliminary command. The smart device may acquire the preliminary command and re-enter the listening state. The smart device may acquire the preliminary command in the listening state and re-open or initialize the listening window.

1.4.4 Feedback State

The smart device may have a feedback state. In the feedback state, the smart device may output feedback corresponding to a voice command. The smart device may acquire the voice command and be changed to the feedback state.

In the feedback state, the smart device may acquire feedback data corresponding to the voice command. In response to the transmission of a voice and/or a voice command to an external device, the smart device may acquire feedback data corresponding to the voice command. The feedback data may be talk-back data or display-back data.

In the feedback state, the smart device may output feedback on the basis of the feedback data. In the feedback state, the smart device may output a talk-back or a display-back corresponding to the voice command. The smart device may output a talk-back or a display-back including information requested by the voice command. In the feedback state, the smart device may output the talk-back and the display-back together or sequentially.

In the feedback state, the smart device may acquire a hot word.

The smart device may acquire a hot word in the feedback state and be changed to the listening state.

1.5 Operation

The smart device may perform various operations. The smart device may perform various operations accompanying the above-described state changes. The basic operation process and additional operations of the smart device will be described below with reference to some embodiments.

1.5.1 Basic Process: Feedback Operation

According to an embodiment of the present disclosure, the smart device may acquire a hot word, acquire a voice command, and output feedback.

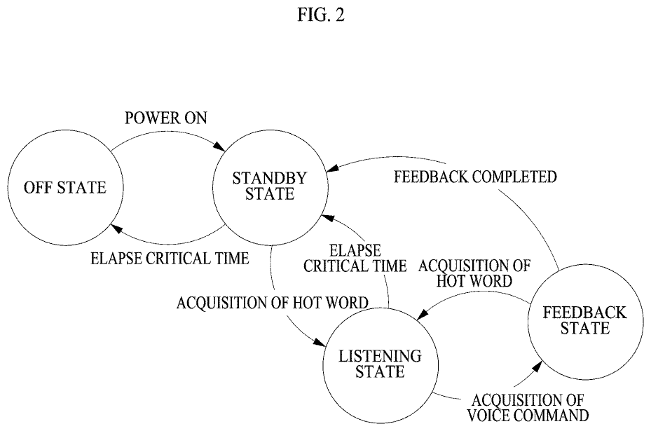

FIG. 2 shows a change in state of a smart device according to an embodiment of the present disclosure. The operation of the smart device according to an embodiment of the present disclosure will be described below with reference to FIG. 2.

The smart device may be changed from the off state to the standby state. The smart device may be changed from the off state to the standby state by user manipulation.

The smart device may be changed from the standby state to the listening state. The smart device may open the listening window in the standby state, acquire a voice including a hot word, and be changed to the listening state.

The smart device may be changed from the listening state to the feedback state. The smart device may acquire a voice that includes a voice command and that is uttered by a user in the listening state and may be changed to the feedback state.

When the output of feedback is completed, the smart device may be changed to the standby state. In some cases, when the output of feedback is completed, the smart device may be changed to a command state. Depending on the type of feedback, the smart device may be changed to the command state after the feedback is output. For example, when the output feedback requests a user command, the smart device may be changed to the command state after the feedback is output.

The smart device may be changed from the feedback state to the listening state. In the feedback state, the smart device may acquire a preliminary command, for example, a hot word, while outputting feedback. After acquiring the preliminary command while outputting the feedback, the smart device may be changed to the listening state.

The smart device may be changed from the standby state or the listening state to the off state. When a hot word is not acquired within a predetermined time, the smart device may be changed from the standby state or the listening state to the off state.

1.5.2 User Location collection Operation

The smart device may acquire and store user location information. The smart device may acquire basic information related to a user location and forward the basic information to an external apparatus. The user location information may include location information of a plurality of users.

The user location information may include distance information from a user's smart device. The user location information may include information on an angular displacement from a reference direction of the user's smart device.

When the smart device is changed from the off state to the standby state, the smart device may acquire the user location information. When a user's voice is acquired, the smart device may acquire the user location information.

The smart device may collect the user location information using the above-described optical sensor module. The smart device may acquire the user location information on the basis of space information acquired using the optical sensor module.

The smart device may collect the user location information using the above-described microphone module. The smart device may acquire a voice uttered by a user using a plurality of microphones and collect user location information in consideration of a direction in which the voice is uttered.

The smart device may store the acquired location information. The smart device may store the acquired location information in the form of a look-up table. The smart device may forward the acquired location information to an external apparatus (e.g., a service apparatus).

In the standby state, the listening state, or the feedback state, the smart device may acquire the user location information. The smart device may periodically acquire the user location information.

The smart device may output feedback in consideration of the user location information. The smart device may determine a talk-back output direction in consideration of the user location information. The smart device may determine a display-back output location and/or direction in consideration of the user location information. These will be described in detail below in Section “User-oriented Feedback.”

1.6 Device Form

The above-described smart device may be implemented in various forms. The form of the smart device will be described below with reference to some embodiments.

1.6.1 First Type: Display Type

According to an embodiment of the present disclosure, the smart device may be provided in the form of a smart display equipped with a display capable of providing a touch interface. The smart device may acquire a voice command and output a talk-back or a display-back.

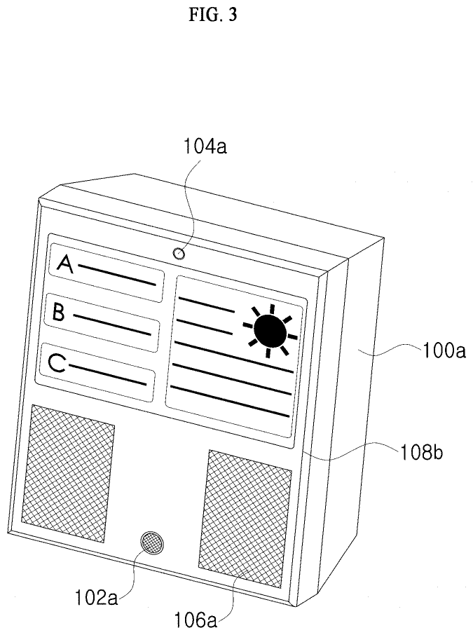

FIG. 3 shows a smart display 100a according to an embodiment of the present disclosure. Referring to FIG. 3, the smart display 100a may include a microphone 102a, a speaker 106a, and a display 108a. Also, optionally, the smart display 100a may include a camera 104a.

The smart display 100a may acquire a voice command using the microphone 102a and may output a talk-back using the speaker 106a or output a display-back through the display 108a.

1.6.2 Second Type: Wall Type

According to an embodiment of the present disclosure, the smart device may be an example of a smart projector equipped with a projector module and may be provided in the form of a smart projector configured to emit light upward.

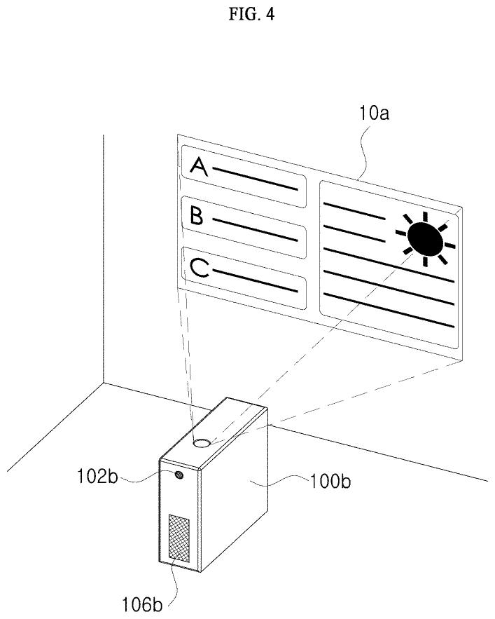

FIG. 4 shows a smart projector 100b according to an embodiment of the present disclosure. Referring to FIG. 4, the smart projector 100b according to an embodiment of the present disclosure may include a microphone 102b and a speaker 106b. Although not shown, the smart projector 100b may include a camera.

Referring to FIG. 4, the smart projector according to an embodiment of the present disclosure may emit light upward. The smart projector may project a picture or an image onto any wall surface. A projection area 10a in which the smart projector projects a picture or an image may be changed. The size or location of the projection area 10a may be changed.

A direction in which a picture is to be projected may be determined such that the picture is easy to view. A direction in which a picture is to be projected may be determined such that the picture is easy to view on a side opposite to a side on which the smart projector projects the picture. In this embodiment, the smart projector may project a picture such that a lower portion of the picture is located at a lower portion of a wall surface. In other words, the smart projector may project a picture such that the picture is projected onto a wall surface in an upright direction.

Also, although not shown, the smart projector 100b may further include a sensor unit to sense a gesture event or a touch event that occurs in the projection area.

1.6.3 Third Type: Table Type

According to an embodiment of the present disclosure, the smart device may be an example of the above-described smart projector and may be provided in the form of a smart projector configured to emit light downward.

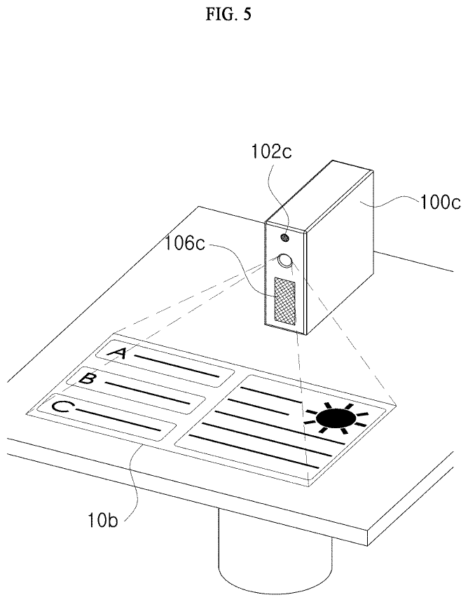

FIG. 5 shows a smart projector 100c according to an embodiment of the present disclosure. Referring to FIG. 5, the smart projector 100c according to an embodiment of the present disclosure may include a microphone 102c and a speaker 106c. The smart projector 100c may further include a camera or a sensor unit.

Referring to FIG. 5, the smart projector 100c according to an embodiment of the present disclosure may emit light downward. The smart projector 100c may project a picture or image on a floor or table on which the smart projector 100c is located.

The size or location of a projection area 10b may be changed. A direction in which a picture is to be projected may be determined such that the picture is easy to view on a side on which the smart projector projects the picture. In this embodiment, the smart projector may project a picture such that a lower portion of the picture is located at an outside of a table (e.g., a location far from the device).

1.6.4 Fourth Type: Manually Rotatable (Rolling) Type

According to an embodiment of the present disclosure, the above-described smart projector may have a plurality of positions. The smart projector may operate in a first position or a second position. The smart projector may emit light upward or downward according to a position change.

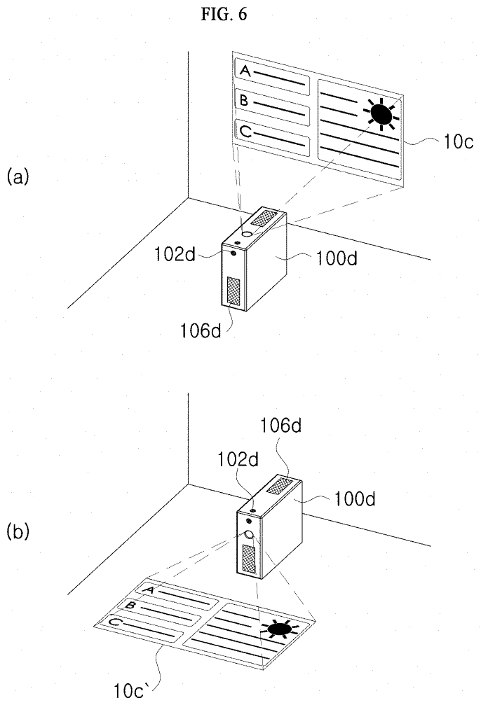

FIG. 6 shows a smart projector 100d according to an embodiment of the present disclosure. Referring to FIG. 6, the smart projector 100d according to an embodiment of the present disclosure may operate in the first position in which a first face is an upper face (FIG. 6(a)) and in the second position in which a second face different from the first face is an upper face (FIG. 6(b)). An operation corresponding to the position of the smart projector 100d will be described below with reference to FIG. 6.

Referring to FIG. 6, the smart projector 100d may include a microphone 102d and a speaker 106d. The smart projector 100d may selectively include a sensor unit or a camera.

Referring to FIG. 6(a), when the smart projector 100d is in the first position (e.g., a wall projection position), the smart projector 100d may emit light upward to a wall. When the smart projector 100d is in the first position, the smart projector 100d may operate similarly to the smart projector 100b of the second type.

Referring to FIG. 6(b), when the smart projector 100d is in the second position (e.g., a table projection position), the smart projector 100d may emit light downward to a floor or a table. When the smart projector 100d is in the second position, the smart projector 100d may operate similarly to the smart projector 100c of the third type.

The position of the smart projector 100d may be changed. The position of the smart projector 100d may be manually changed. The position of the smart projector 100d may be automatically changed by a driving unit.

When the position of the smart projector 100d is changed, the operation of at least one module included in the smart projector 100d may be changed. When the position of the smart projector 100d is changed, the operation of at least one of a speaker module, a microphone module, and a sensor module included in the smart projector 100d may be changed. As an example, when the smart projector 100d is changed from the first position to the second orientation, the speaker 106d which outputs audio may be changed.

As another example, when the position of the smart projector 100d is changed, the direction in which the smart projector 100d projects light may be changed. When the position of the smart projector 100d is changed, a projection direction of a picture 10c(10c′) projected from the smart projector 100d may be changed. In detail, the smart projector 100d may project a picture in the first position such that a lower portion of the picture is close to the smart projector 100d and may project a picture in the second position such that a lower portion of the picture is far from the smart projector 100d.

The aforementioned description is based on a case in which the smart projector 100d has the first position and the second position and in which the position of the smart projector 100d is selectively changed between the first position and the second position, but the present disclosure disclosed herein is not limited thereto. The smart projector 100d may be implemented as having three or more positions so that the position of the smart projector 100d can be selectively changed as necessary.

1.6.5 Fifth Type: Rotatable

According to an embodiment of the present disclosure, the smart device may be an example of the above-described smart projector and may be provided in the form of a smart projector with a rotatable light projection direction. The smart projector 100e may project a picture on a wall surface and/or a table and may be provided such that the projection direction of the picture is rotatable.

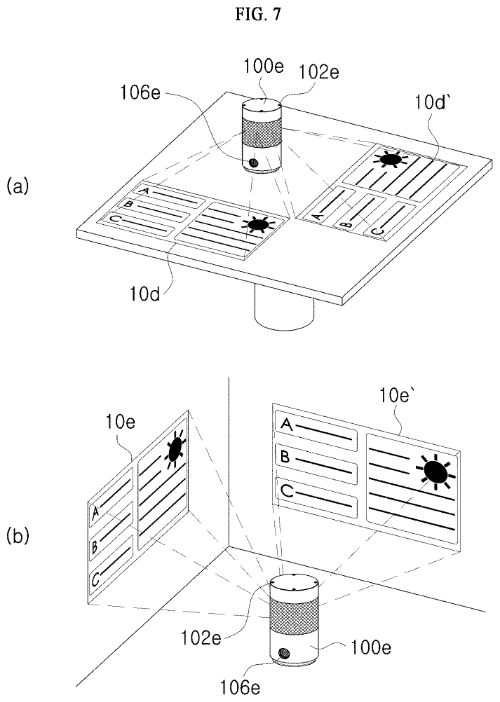

FIG. 7 shows a smart projector 100e according to an embodiment of the present disclosure. Referring to FIG. 7, the smart projector may be implemented such that the picture projection direction is rotatable. The picture projection direction may rotate around a rotary axis of the smart projector.

Referring to FIG. 7, the smart projector 100e may include a microphone 102e and a speaker 106e. The smart projector 100e may selectively include a sensor unit or a camera.

Referring to FIG. 7(a), the smart projector 100e may emit light downward and may be provided such that the projection direction of the light is rotatable. The smart projector 100e may be located above a table to project a picture onto an upper surface of the table. The smart projector 100e may rotate the direction in which the image is projected onto the table. For example, the smart projector 100e may rotate the projection direction of the picture so that the projection area can be changed from a first location 10d to a second location 10d′.

Referring to FIG. 7(b), the smart projector 100e may emit light upward and rotate the projection direction of the light. The smart projector 100e may project a picture onto a wall surface. The smart projector 100e may rotate the projection direction of the picture. The smart projector 100e may rotate the projection direction of the picture so that the wall onto which the picture is projected can be changed. For example, the smart projector 100e may rotate the projection direction of the picture so that the projection area can be changed from a third location 10e to a fourth location 10e′.

The smart projector 100e may operate in one mode selected from among a plurality of modes including the wall projection mode (the first mode) and/or the floor projection mode (the second mode).

2. Voice Interface

2.1 Overview

According to an embodiment of the present disclosure, the smart device may provide a voice interface for acquiring a voice command from a user.

The smart device may provide a speech control environment to a user by performing various operations in response to the user's voice command.

Some embodiments of a smart device configured to provide a voice interface and a control method thereof will be described below. In the following embodiment, the smart device may be a smart display equipped with a display for displaying pictures or a smart projector equipped with a beam projector configured to output pictures.

2.2 Process

The smart device may provide a voice interface, acquire a voice including a voice command through the voice interface, and output information corresponding to the voice command. The smart device may provide the voice interface (or a speech control environment) to a user and output information corresponding to a voice command included in the user's voice in various forms.

The smart device may acquire a voice command through the voice interface and provide a voice interface for outputting information corresponding to the voice command in the form of a speech (e.g., a talk-back).

The smart device may acquire a voice command through the voice interface and provide a voice interface for outputting information corresponding to the voice command in the form of a picture (e.g., a display-back). In particular, in the case of a smart display or a smart projector that outputs pictures, the smart device may output the information corresponding to the voice command through the display-back.

2.3 Content

The smart device may provide user content that supports the voice interface. The smart device may provide the user content that supports the voice interface, acquire a user's voice command related to the user content, and perform an operation corresponding to the voice command.

The smart device may visually or aurally provide the user content to the user. The user content may be provided as audio content or video content. The user content may include multimedia content.

The smart device may display the user content in a display area. The smart device may output user content including visual information using a display or a projector module. In other words, the display area in which the user content is to be displayed may be provided in a display screen or a projection image. Herein, unless otherwise specified, the user content is described as being provided together with visual information.

The user content may include information requested by a voice command. The user content may include a plurality of objects (or items) selectable by the user's voice command. The user content may include a list having the plurality of objects.

The user content may be stored in a separate server and provided to a smart device when requested by a user's voice command. The user content may be provided by a separate provider.

Corresponding identifiers may be allocated to the objects included in the user content. The identifiers allocated to the objects may be ordinal numbers. The smart device may display the plurality of objects included in the user content. The smart device may display the objects together with the respective identifiers.

The user content may be provided in an at least partially scrollable form. The user content may be scrollable in at least one direction according to a user command.

A connection operation may be designated for each of the plurality of objects. The smart device may acquire a voice command for selecting any object and perform a connection operation corresponding to the object.

Each object may include visual information for a corresponding connection operation. For example, each object may include a thumbnail, an icon, or the like of a connected image. Each object may include an image, a price, specification information, or the like of a product.

Each object may be a media object connected to media content. For example, each object may be a media object including a name, a representative image, or the like of a song, a picture, or the like indicating a music video, a TV program, a song, or the like. A media object may include a link for playing corresponding media content. In this case, the connection operation may be implemented as the playing of a selected song, picture, or the like, the addition of a selected song, picture, or the like to a playlist, and the generation of an associated list of a song, a picture, or the like.

Each object may be a product object for sale goods. For example, the user content may provide a shopping page, and each object may be a product object including a name, an image, and the like of a product for sale. In this case, the connection operation may be implemented as the opening of a detail page of a selected product, the addition of a selected product to a shopping basket, the opening of a purchase window of a selected product, or the like.

The smart device may display a portion of information included in the user content. The smart device may determine the display area such that some of the plurality of objects included in the user content can be displayed. The smart device may display or project the display area.

The smart device may change a displayed area of the user content. The display area may include a plurality of objects. The objects included in the display area may be changed. The number of objects included in the display area may be changed. For example, the display area may be enlarged (zoomed in) or reduced (zoom out).

The smart device may acquire a voice command or a touch event and then change the display area. The change of the display area according to the voice command will be described in detail in Section: Speech Control and Content Display.

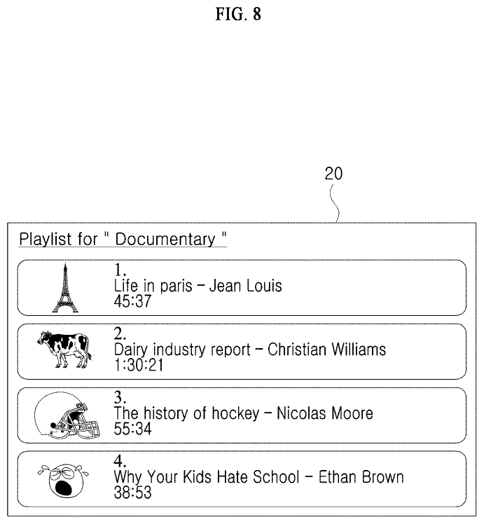

FIG. 8 is a diagram illustrating user content according to an embodiment of the present disclosure.

Referring to FIG. 8, the smart device according to an embodiment of the present disclosure may display user content including a plurality of videos in a display area 20.

The user content may include a list of links which are each connected to a video. The user content may include a plurality of objects which include a link connected to a designated video respectively.

For example, the smart device may acquire a user's voice command that requests a “documentary video” and may output user content including a plurality of documentary pictures to the display area 20 in the form of a list having a plurality of objects including respective links for a plurality of documentary videos.

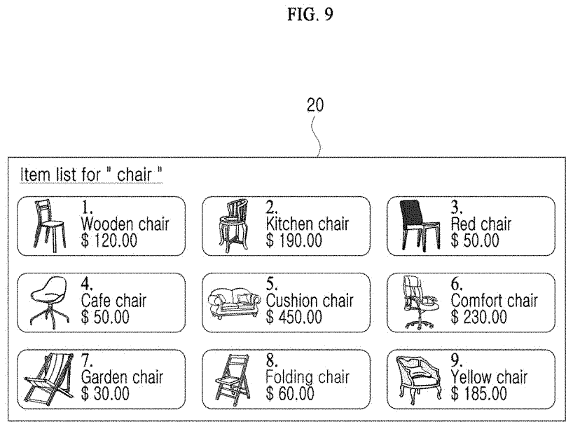

FIG. 9 is a diagram illustrating user content according to an embodiment of the present disclosure.

Referring to FIG. 9, the smart device according to an embodiment of the present disclosure may output user content including a plurality of pieces of product information to a display area 20. The user content may include a plurality of objects each including a connection link connected to a detail page or a purchase page of a product.

For example, the smart device may acquire a user's voice command that requests a “purchasable chair list” and may output user content including a plurality of pieces of information on “chairs” for sale to the display area 20 in the form of a plurality of listed objects each including a chair thumbnail.

3. Speech Control

According to an embodiment of the present disclosure, the smart device may provide a speech control environment to a user and may provide a speech control environment to the user by performing various operations according to a voice command acquired through the voice interface.

The smart device may be a smart display including a display or a smart projector including a projector module. The smart display may provide a touch interface for recognizing a touch event applied to the display in addition to the voice interface. The smart projector may provide a touch interface for recognizing a touch event applied to a projected picture in addition to the voice interface.

The speech control method of the smart device will be described below with reference to some embodiments.

3.1 Content Display Control

According to an embodiment of the present disclosure, the smart device may acquire a voice command and change a content display state. The smart device may acquire a user's voice command and scroll a displayed screen. The smart device may acquire a voice command and scroll a displayed screen longitudinally or transversely.

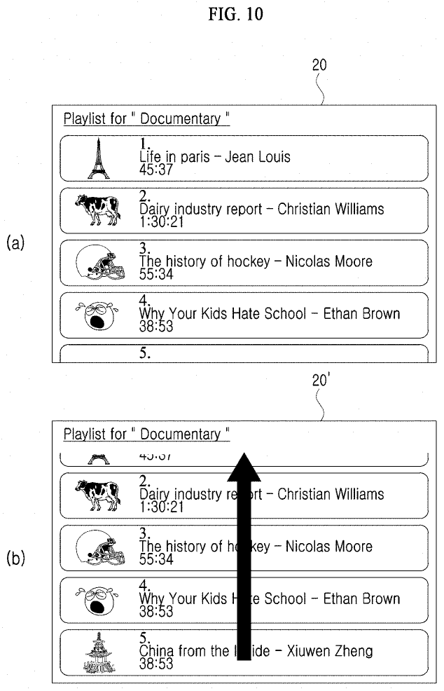

FIG. 10 is a diagram illustrating the control of a display screen of a smart device according to an embodiment of the present disclosure.

Referring to FIG. 10, the smart device according to an embodiment of the present disclosure may display user content including information pieces or objects listed longitudinally, acquire a user voice that requests the lengthwise movement of the content, and move a displayed area of the user content downward (scroll down). For example, the smart device may acquire a user voice including a voice command requesting that the display area be moved downward, e.g., a voice command “scroll down” and may scroll the displayed user content down.

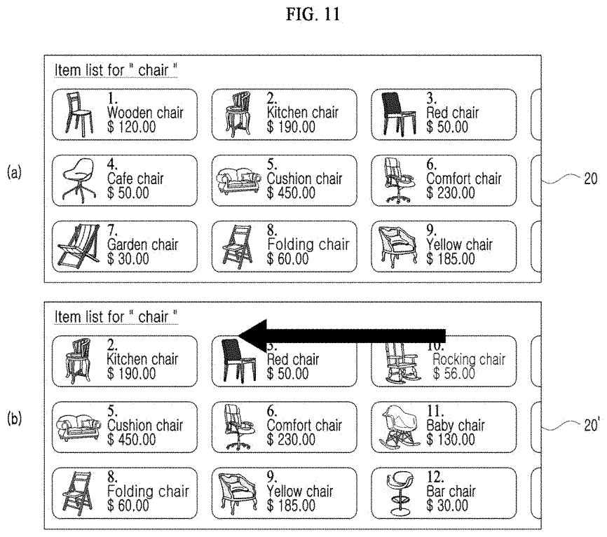

FIG. 11 is a diagram illustrating the control of a display screen of a smart device according to an embodiment of the present disclosure.

Referring to FIG. 11, the smart device according to an embodiment of the present disclosure may display user content including object icons listed transversely, acquire a user voice that requests the widthwise movement of the displayed screen, and move a displayed area of the user content to the right. For example, the smart device may acquire a user's voice command “scroll right” and scroll displayed user content to the right.

Meanwhile, the aforementioned description is based on a case in which the smart device acquires a voice and scrolls an output screen, but the present disclosure disclosed herein is not limited thereto. For example, when the smart device includes a display, the smart device may acquire a touch event applied to the display and change the display state of the output screen. Alternatively, the smart display is a smart projector including a projector module, and the smart projector may acquire a gesture event applied to a projected screen and change the display state of the output screen.

3.2 Selection of Object

According to an embodiment of the present disclosure, the smart device may acquire a user's voice command for selecting one of a plurality of objects (a selection command). The smart device may provide content including a plurality of objects, acquire a user's voice command for selecting one object from among the plurality of objects through a voice interface, and perform a connection operation designated for the selected object.

For example, the smart device according to an embodiment of the present disclosure may provide content including a plurality of videos while displaying a video list including links for playing the videos and outputting a selected video in response to the reception of a user's voice command for selecting one video from among the plurality of videos.

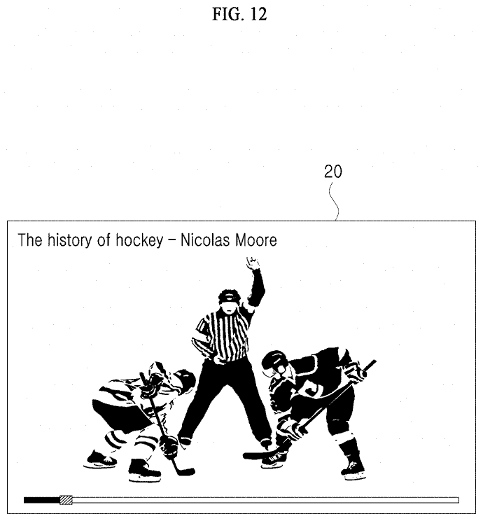

FIG. 12 is a diagram illustrating a connection operation according to an embodiment of the present disclosure.

Referring to FIG. 12, the smart device according to an embodiment of the present disclosure may display user content including a plurality of videos, acquire a voice that is uttered by a user and that includes a voice command for selecting one video from among the plurality of videos, and output the video selected by the voice command.

For example, while a screen including a plurality of picture objects is displayed as shown in FIG. 8, the smart device may acquire a user's voice command for requesting that picture #3 be played and may play picture #3, i.e., “The History of Hockey.”

As another example, the smart device according to an embodiment of the present disclosure may provide user content including a plurality of products, display a product list including links of detail pages or purchase pages of the products, and output a detail page, a purchase page, or the like of a selected product in response to the reception of a user's voice command for selecting one product from among the plurality of products.

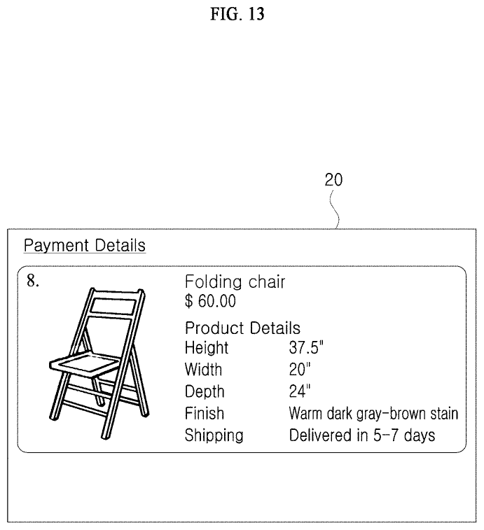

FIG. 13 is a diagram illustrating a connection operation according to an embodiment of the present disclosure. Referring to FIG. 13, while the screen shown in FIG. 9 is displayed, the smart device according to an embodiment of the present disclosure may acquire a user's voice command for selecting chair #8 and display detailed information on chair #8.

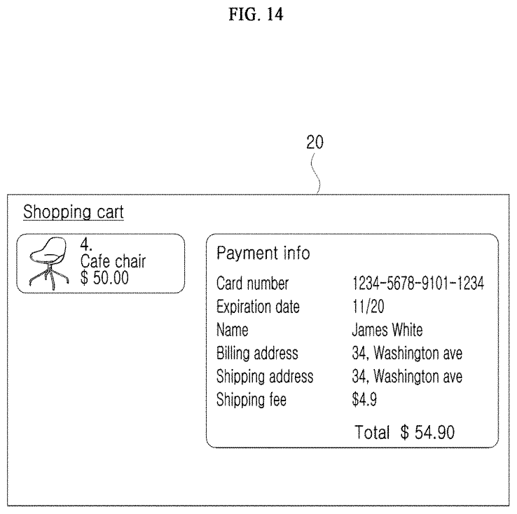

FIG. 14 is a diagram illustrating a connection operation according to an embodiment of the present disclosure. Referring to FIG. 14, while the screen shown in FIG. 9 is displayed, the smart device according to an embodiment of the present disclosure may acquire a user's voice command for requesting “selection of chair #4” or “purchase of chair #4” and output the purchase page of chair #4.

Meanwhile, the connection operations described in FIGS. 12 to 14 are merely examples, and according to the smart device disclosed herein, various connection operations may be applied.

3.2.1 Selection of Plurality of Objects

According to an embodiment of the present disclosure, the smart device may provide content including a plurality of objects, acquire a user's voice command for selecting at least two objects from among the plurality of objects (a multi-selection command), and perform connection operations for the selected objects.

For example, when a plurality of purchasable product options are provided or when a song list is provided, a multi-selection command environment may be provided so that a user can select a plurality of target products or a plurality of target songs to request that the products be ordered or that the songs be played.

According to an embodiment of the present disclosure, the smart device may output content including a plurality of selectable objects, receive a voice command for selecting at least two objects from among the plurality of selectable objects, and perform connection operations linked to selected objects in response to the reception of the voice command for selecting the at least two objects.

According to an embodiment of the present disclosure, the smart device may determine a plurality of objects to be selected on the basis of a voice command included in a voice acquired with a reference period of time. The smart device may acquire a voice command including a predetermined indicator and determine a plurality of objects to be selected on the basis of the voice command.

As an example, a method of controlling the smart device may include providing content including a plurality of song lists, acquiring a user's voice command for selecting two or more songs, and performing a connection operation to add the selected songs to a playlist. Alternatively, the smart device may display the playlist to which the selected songs are added. The smart device may play the selected songs.

As another example, a method of controlling the smart device may include providing content including a plurality of product lists, acquiring a user's voice command for selecting two or more products, and performing a connection operation to display a shopping cart screen to which the selected products are added or the purchase pages of the selected products. The smart device may acquire a user's voice command for selecting products and output feedback informing the user that the selected products are added to a shopping cart.

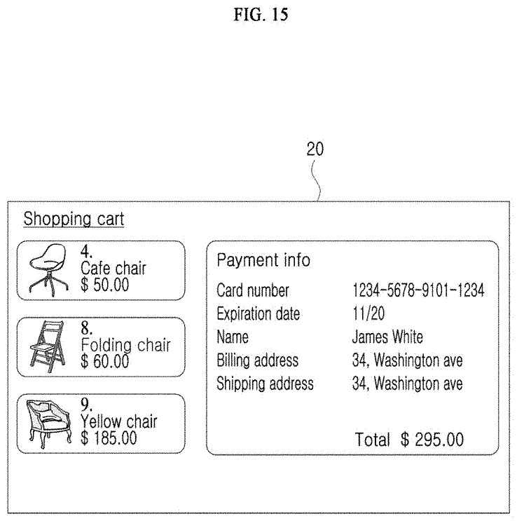

FIG. 15 is a diagram illustrating a connection operation according to an embodiment of the present disclosure.

Referring to FIG. 15, the smart device according to an embodiment of the present disclosure may display content including a plurality of products as shown in FIG. 9, acquire a user's voice command for selecting at least two products from among the plurality of products, and output purchase pages of the selected products in response to the acquisition of the voice command.

3.2.2 Preliminary Selection

According to an embodiment of the present disclosure, the smart device may output user content including a plurality of objects, acquire a voice command for selecting at least one object from among the plurality of objects, perform a preliminary selection procedure on the selected object, and then perform a connection operation linked to the selected object.

For example, when the voice command is misrecognized or is recognized as a selection command even though the user did not intend to make a selection, the preliminary selection procedure may be used as a check procedure before the connection operation is performed.

According to an embodiment of the present disclosure, the smart device may output user content including a plurality of objects, acquire a voice command for selecting at least one object from among the plurality of objects, and display executable connection operations as a preliminary selection procedure for the selected object.

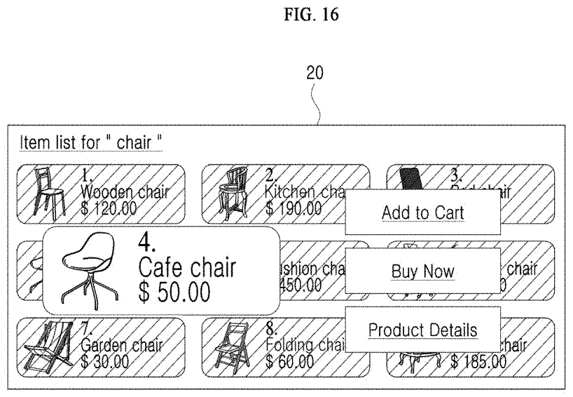

FIG. 16 is a diagram illustrating a preliminary selection according to an embodiment of the present disclosure.

Referring to FIG. 16, while content including a plurality of products is displayed as shown in FIG. 9, the smart device according to an embodiment of the present disclosure may acquire a voice command for selecting product #4 and display that connection operations for adding product #4, which is preliminarily selected, to a shopping basket, immediately purchasing product #4, or opening the detail page of product #4 are possible.

According to another embodiment of the present disclosure, the smart device may output user content including a plurality of objects, acquire a voice command for preliminarily selecting at least one object from among the plurality of objects, and change the display state of the preliminarily selected object.

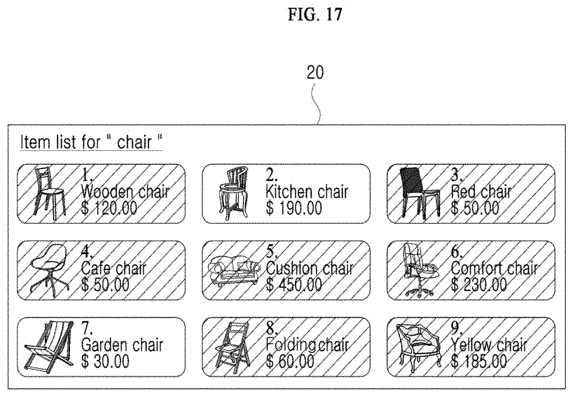

FIG. 17 is a diagram illustrating a connection operation according to an embodiment of the present disclosure.

Referring to FIG. 17, the smart device may output user content including a plurality of products, acquire a user's voice command for selecting product #2 and product #7, and change the display states of product #2 and product #7. For example, the brightness of selected objects may be different from the brightness of the unselected objects. In detail, the smart device may decrease the brightness of objects indicating the products other than product #2 and product #7. Alternatively, the smart device may change the color of objects indicating product #2 and product #7.

3.2.3 Selection of Object Not Displayed

As described above, depending on the control state of the smart device, all of a plurality of objects included in content may not be displayed on one screen. The objects displayed on the screen may be changed while the screen is scrolled according to a user's scroll request.

An operation of the smart device when a voice including a voice command for selecting an object that is not included in a changed screen is received from a user will be described below with reference to some embodiments.

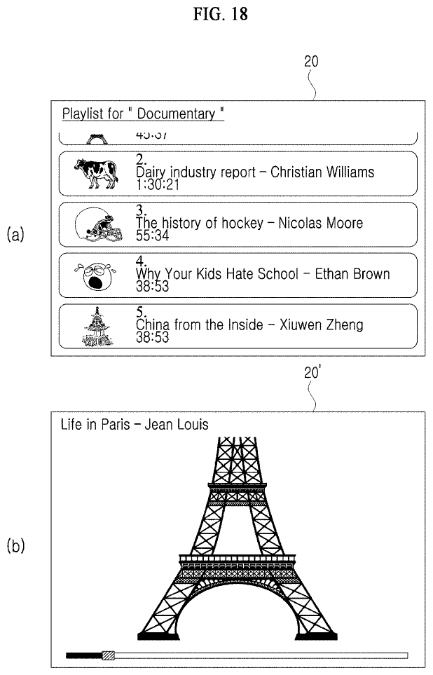

FIG. 18 is a diagram illustrating the operation of a smart device according to an embodiment of the present disclosure.

Referring to FIG. 18(a), the smart device according to an embodiment of the present disclosure may display a list including a plurality of picture links and scroll through the list according to a user's request. For example, as shown in FIG. 18(a), the smart device may be used while the list is scrolled and thus some objects positioned in an upper portion of the list are not displayed. In this case, the smart device may acquire a user's voice command for selecting an object that is not displayed, e.g., picture #1.

Referring to FIG. 18(b), the smart device may acquire a user's voice command for selecting picture #1 while picture #1 is not displayed and may play picture #1.

Meanwhile, when the case of the user selecting an object not included in a screen is treated the same as the case of the user selecting an object included in the screen, the details of the object not displayed depend on the user's memory, and thus problems such as a connection operation being performed on an incorrectly selected object may occur.

For example, as shown in the drawing, a case of a selected object (the second video) being present in a display area displayed through a display module (see the left side) and a case of no selected object being present in the display area may be considered. Accordingly, there is a need for a method of controlling the smart device to perform a connection operation in consideration of whether a selected object is displayed.

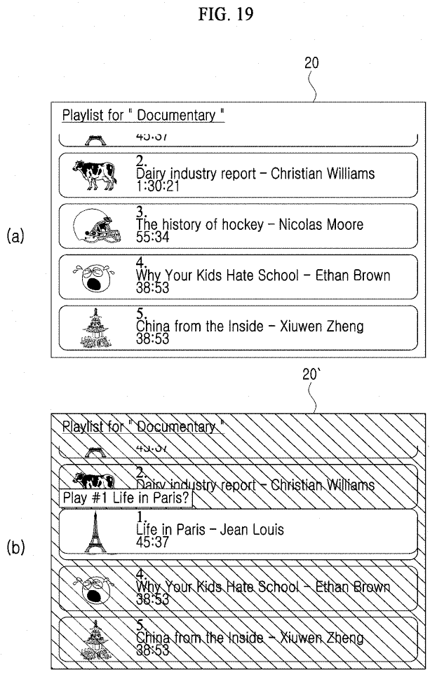

FIG. 19 is a diagram illustrating the operation of a smart device according to an embodiment of the present disclosure.

Referring to FIG. 19(a), while a list including a plurality of picture links is scrolled down according to a user's request such that some objects, e.g., picture #1 is not displayed, the smart device according to an embodiment of the present disclosure may acquire the user's voice command for selecting an object not displayed, e.g., a voice command for requesting that picture #1 be played.

Referring to FIG. 19(b), the smart device may acquire the voice command for requesting that picture #1 be played while an object corresponding to picture #1 is not displayed and may overlay a pop-up window for requesting the confirmation of the playing of picture #1 on a display screen. In this case, the smart device may additionally output a voice guide for requesting the conformation of the playing of picture #1.

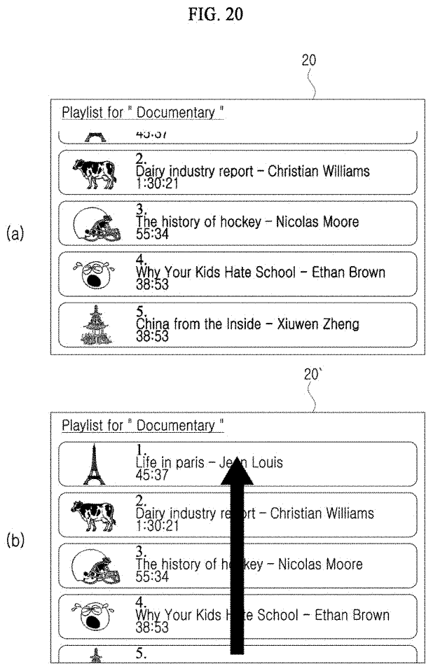

FIG. 20 is a diagram illustrating the operation of a smart device according to an embodiment of the present disclosure.

Referring to FIG. 20(a), while a list including a plurality of picture links is scrolled down such that some objects, e.g., picture #1 is not displayed, the smart device according to an embodiment of the present disclosure may acquire a user's voice command for selecting an object not displayed, e.g., a voice command for requesting that picture #1 be played.

Referring to FIG. 20(b), the smart device may acquire a voice command for selecting an object not displayed while some objects are not displayed and may change a display area of content to display the object corresponding to picture #1. For example, the smart device may acquire a voice command for selecting picture #1 while the object corresponding to picture #1 is not displayed and may scroll the screen to display the object corresponding to picture #1. The smart device may additionally output a guide voice informing the user that picture #1 is to be displayed simultaneously with the screen change.

The above-described embodiments are merely examples. Accordingly, when a voice command for selecting an object not displayed on a screen is acquired from a user, the smart device according to the present disclosure may output various forms of feedback to improve user convenience.

A method of controlling the smart device when a user selects an object not displayed on a screen as in the above embodiments will be described in detail below.

4. Motion Algorithm—Case of Selecting Object Not Displayed

As the method of controlling the smart device that provides the above-described voice interface, a control method in which the smart device performs the following operations in consideration of the display state of an object selected by a user will be described with reference to some embodiments.

4.1 Algorithm

According to an embodiment of the present disclosure, the method of controlling the smart device may include outputting content including a plurality of selectable objects, receiving a voice command for selecting one object from among the plurality of selectable objects, and performing a connection operation linked to the selected object in response to the reception of the voice command for selecting the object.

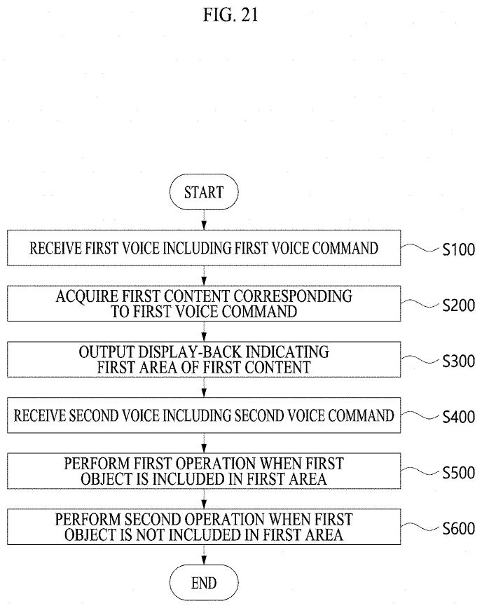

FIG. 21 is a flowchart illustrating a method of controlling a smart device according to an embodiment of the present disclosure. In this case, the smart device may be a smart projector configured to emit light and output a display-back or a smart display including a display and outputting a display-back to the display.

Referring to FIG. 21, the method of controlling the smart device according to an embodiment of the present disclosure may include operations of receiving a first voice including a first voice command (S100), acquiring first content corresponding to the first voice command (S200), outputting a display-back indicating a first area of the first content (S300), receiving a second voice including a second voice command (S400), performing a first operation when a first object is included in the first area (S500), and performing a second operation when the first object is not included in the first area (S600).

The operation of acquiring first content corresponding to the first voice command (S200) may be implemented as the first content including a plurality of selectable objects and each of the plurality of objects including an identifier allocated to the corresponding object. The identifier may be an ordinal number determined based on a state in which the objects are aligned.

The operation of outputting a display-back indicating a first area of the first content (S300) may further include outputting a display-back indicating the first area including some of the plurality of objects of the first content. In other words, the first content may include a list including the plurality of objects, and the smart device may output a portion of the list included in the first content to the display area. The first content may be scrolled in at least one direction according to a user command. The first area may be changed when the content or the list is scrolled. When the displayed first area is changed, the plurality of objects included in the first area may be changed.

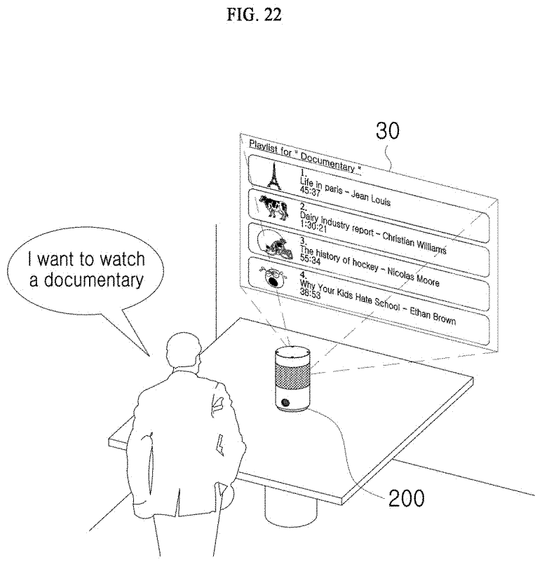

FIG. 22 is a diagram illustrating a method of controlling a smart device 200 according to an embodiment of the present disclosure.

Referring to FIG. 22, the method of controlling the smart device 200 may include receiving a voice including a voice command, acquiring user content corresponding to the voice command, and outputting a display-back indicating a partial area of the user content.

In detail, referring to FIG. 22, the smart device 200 according to an embodiment of the present disclosure may receive a first voice including a first voice command for requesting a documentary picture (e.g., “I want to watch a documentary”) and output the first area of the first content corresponding to the first voice command (e.g., user content including a plurality of documentary picture links) to a display area 30.

In the operation of receiving a second voice, which is uttered by a user, including a second voice command (S400), the second voice command may request an operation (feedback) related to the first object. The second voice command may be implemented as including a first identifier corresponding to a first object included in a plurality of objects and requesting that a first operation related to the first object be performed.

When the first object is included in the first area, the operation of performing a first operation (S500) may include performing the first operation immediately without a separate notification. When the first object is included in the first area, the smart device may perform the first operation immediately without separate feedback.

The second voice command may be a voice command for requesting that second content connected to the first object be displayed. In this case, the first operation may include displaying the second content connected to the first object.

When the first object is not included in the first area, the operation of performing a second operation (S600) may include performing the second operation of requesting the user to check the first object and the performance of the first operation on the first object.

The operation of performing a second operation (S600) may be implemented as including performing the first operation when a third voice including a third voice command for checking the performance of the first operation is received in response to the second operation.

The operation of performing a second operation (S600) may be implemented as the second operation including outputting feedback for requesting that the performance of the first operation on the first object and the first identifier be checked.

The operation of performing a second operation (S600) may be implemented as the second operation including outputting a display-back or a talk-back informing the user that the first operation corresponding to the second voice command is related to the first object.

The operation of performing a second operation (S600) may be implemented as the second operation including displaying a second area determined to include the first object of the first content.

The operation of performing a second operation (S600) may be implemented as the second operation including overlapping a popup window including the first object with the first area while the first area is displayed.

The operation of performing a second operation (S600) may be implemented as the second operation including outputting a guide voice requesting that the performance of the first operation on the first object be checked.

Meanwhile, the method of controlling the smart device according to an embodiment of the present disclosure may further include receiving a fourth voice including a fourth voice command for requesting that a displayed area be scrolled and outputting a display-back indicating a third area different from the first area of the first content. In this case, the operation of performing a first operation may be implemented as performing the first operation when the first object is included in the third area, and the operation of performing a second operation may be implemented as performing the second operation when the first object is not included in the third area.

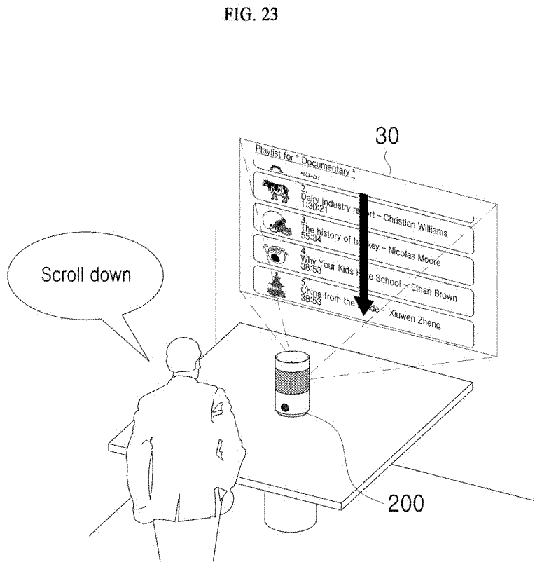

FIG. 23 is a diagram illustrating a method of controlling a smart device 200 according to an embodiment of the present disclosure.

Referring to FIG. 23, the method of controlling the smart device 200 according to an embodiment of the present disclosure may include acquiring a voice including a voice command for requesting that a displayed area be changed and changing a portion of the displayed area of the user content.

In detail, referring to FIG. 23, the smart device 200 according to an embodiment of the present disclosure may receive a user's voice command for requesting that the displayed area be scrolled downward (e.g., a voice command “scroll down”) and scroll the display area 30 downward.

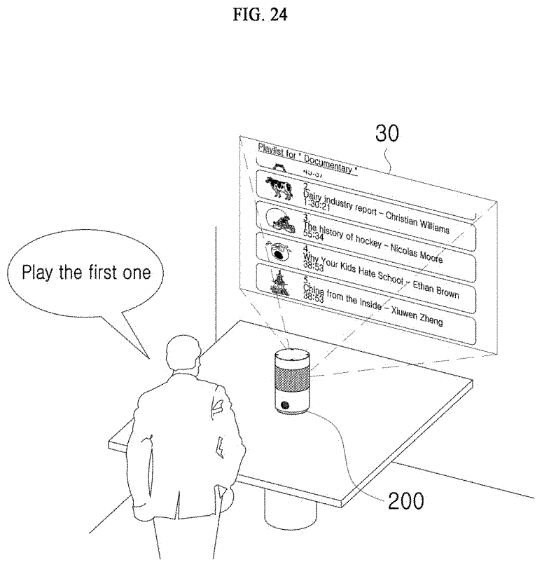

FIG. 24 is a diagram illustrating a method of controlling a smart device 200 according to an embodiment of the present disclosure.

Referring to FIG. 24, the method of controlling the smart device 200 may include acquiring a voice command for selecting an object not displayed.

For example, as described above with reference to FIG. 23, while the display area is scrolled by a user's voice command so that an object included in the display area 30 is changed, the smart device may acquire a user command for selecting an object pushed off a screen.

In detail, referring to FIG. 24, the smart device 200 according to an embodiment of the present disclosure may receive a user's voice command for requesting that picture #1, which is not present in the display area 30, be played (e.g., a voice command “play the first one”).

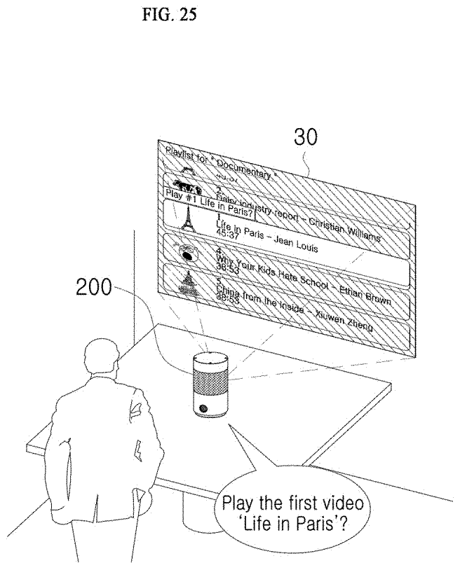

FIG. 25 is a diagram illustrating a method of controlling a smart device according to an embodiment of the present disclosure.

Referring to FIG. 25, the method of controlling the smart device 200 may include acquiring a voice command for selecting an object that is not displayed, displaying a popup window informing the user about the selected object, and outputting a guide voice.

In detail, referring to FIG. 25, the smart device 200 according to an embodiment of the present disclosure may acquire a user's voice command for requesting that picture #1, which is not present in the display area 30, be played and output a popup window guiding picture #1 to be played, outputting a guide voice requesting the confirmation of the playing of picture #1 (e.g., a guide voice “Play the first video, Life in Paris”), or performing both of the output of the guide voice and the display of the popup window.

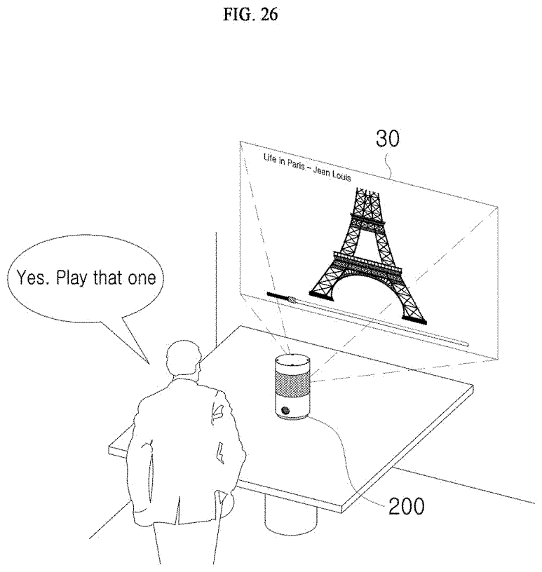

FIG. 26 is a diagram illustrating a method of controlling a smart device according to an embodiment of the present disclosure.

Referring to FIG. 26, the method of controlling the smart device 200 may include receiving the user's voice command for confirming the selected object and performing a connection operation on the selected object in response to the display of the popup window informing the user about the selected object and the output of the guide voice.

In detail, referring to FIG. 26, the smart device 200 according to an embodiment of the present disclosure may output feedback for checking the playing of the first picture not included in the display area 30 as described above with reference to FIG. 25, acquire a user voice uttered in response to the feedback, receive a voice command included in the voice to check the play of the first picture (e.g., a voice command “Yes, play that one”), and play the first picture.

The smart device may check a voice command for checking the playing of the first picture and then immediately play the first picture. Alternatively, even though the user's voice command is not acquired, the smart device may play the first image in a reference time after outputting feedback for checking the playing of the first image.

Meanwhile, according to an embodiment of the present disclosure, the method of controlling the smart device may include receiving a voice command for selecting a plurality of objects from a user in consideration of the type of content output upon the user's request. For example, the smart device may provide a voice interface for allowing a user to select a plurality of songs to form a playlist or select and add a plurality of products to a shopping cart.

In this case, the method of controlling the smart device may include outputting feedback for checking the selection of objects not included in a display area when at least one of a plurality of selected objects is not included in the display area.

4.2 Apparatus

The above-described method of controlling the smart device may be performed by the smart device disclosed herein.

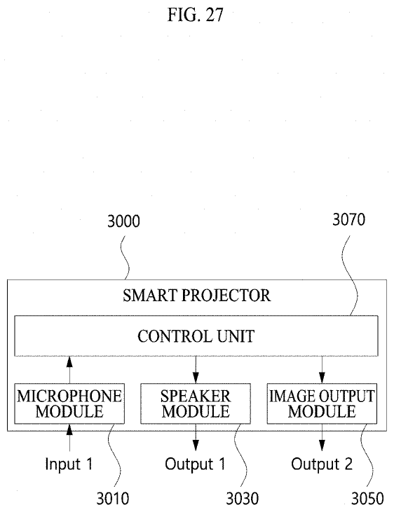

FIG. 27 is a diagram illustrating a smart device 3000 according to an embodiment of the present disclosure.

Referring to FIG. 27, the smart device 3000 according to an embodiment of the present disclosure may include a microphone module 3010 configured to acquire a voice including a voice command, a speaker module 3030 configured to output a talk-back, an image output module 3050 configured to output a display-back, and a control unit 3070.

The image output module 3050 may be one of a projector module configured to emit light to output a display-back and a display module including a display and outputting a display-back using the display.

The control unit 3070 may receive a first voice uttered by a user and including a first voice command through the microphone module. In this case, the first content may include a plurality of selectable objects, and each of the plurality of objects may include an identifier allocated to the corresponding object.

The control unit 3070 may output a display-back indicating a first area including some of the plurality of objects of the first content corresponding to the first voice command through the image output module.

The control unit 3070 may receive a second voice uttered by the user and including a second voice command through the microphone module. In this case, the second voice command may include a first identifier corresponding to a first object included in the plurality of objects and may request that a first operation related to the first object be performed.

The second voice command may be a voice command for requesting that second content connected to the first object be displayed, and the first operation may include displaying the second content connected to the first object.

A second operation may include outputting a display-back or a talk-back for informing the user that the first operation corresponding to the second voice command is related to the first object.

The second operation may include overlapping a popup window including the first object with the first area while the first area is displayed.

The second operation may include outputting a guide voice requesting that the performance of the first operation on the first object be checked.

When the first object is included in the first area, the control unit 3070 may perform the first operation immediately.

When the first object is not included in the first area, the control unit 3070 may perform the second operation of requesting the user to check the first object and the performance of the first operation on the first object. The second operation may include outputting feedback for requesting that the first identifier and the performance of the first operation on the first object be checked.

Furthermore, when the first object is not included in the first area, the control unit 3070 may acquire a second voice command for checking the performance of the first operation through the microphone module and perform the first operation in response to the performance of the second operation.

The method according to an embodiment may be implemented in the form of program instructions executable by a variety of computer means and may be recorded on a computer-readable medium. The computer-readable medium may include program instructions, data files, data structures, and the like alone or in combination. The program instructions recorded on the medium may be designed and configured specifically for an embodiment or may be publicly known and usable by those who are skilled in the field of computer software. Examples of the computer-readable recording medium include a magnetic medium, such as a hard disk, a floppy disk, and a magnetic tape, an optical medium, such as a compact disc read-only memory (CD-ROM), a digital versatile disc (DVD), etc., a magneto-optical medium such as a floptical disk, and a hardware device specially configured to store and perform program instructions, for example, a read-only memory (ROM), a random access memory (RAM), a flash memory, etc. Examples of the computer instructions include not only machine language code generated by a compiler, but also high-level language code executable by a computer using an interpreter or the like. The hardware device may be configured to operate as one or more software modules in order to perform the operations of an embodiment, and vice versa.

Although the present disclosure has been described with reference to specific embodiments and drawings, it will be appreciated that various modifications and changes can be made from the disclosure by those skilled in the art. For example, appropriate results may be achieved although the described techniques are performed in an order different from that described above and/or although the described components such as a system, a structure, a device, or a circuit are combined in a manner different from that described above and/or replaced or supplemented by other components or their equivalents.

Therefore, other implementations, embodiments, and equivalents are within the scope of the following claims.

1. A method for controlling a smart device configured to obtain a voice command and output various feedbacks corresponding to the voice command, wherein, the feedbacks include a display-back and a talk-back, the method comprising:
receiving a first voice including a first voice command and uttered by a user;
obtaining first contents which correspond to the first voice command, wherein, the first contents include a plurality of selectable objects and each object included in the plurality of objects includes identifier assigned to the objects respectively;
outputting a display-back displaying a first area including a first group which is a part of the plurality objects of the first contents;
receiving a second voice including a second voice command and uttered by the user, wherein the second voice command requests at least part of objects which are not included in the first group among the first contents;
in response to the second voice command, outputting a display-back displaying a second area including a second group which is at least partially different from the first group and included in the plurality of the objects of the first contents;
receiving a third voice including a third voice command and uttered by the user, wherein the third voice command includes a first identifier that corresponds to a first object and requests a first operation related to the first object;
wherein when the first object is included in the second area, performing the first operation; and
wherein when the first object is not included in the second area, performing a second operation requesting confirmation of performing of the first operation related to the first object and the first object, to the user, including visual contents.

2. The method for controlling a smart device in claim 1, wherein,
the performing of the second operation further comprises, when a fourth voice confirming performing of the first operation is received in response to the second operation, performing the first operation.

3. The method for controlling a smart device in claim 1, wherein,
the performing of the second operation further comprises, outputting a feedback requesting the confirmation of the first identifier and the first operation related to the first object.

4. The method for controlling a smart device in claim 1, wherein,
the third voice command is a voice command requesting displaying of a second contents related to the first object, and
the first operation includes displaying the second contents related to the first object.

5. The method for controlling a smart device in claim 1, wherein,
the performing of the second operation further comprises, outputting a display-back or a talk-back for notifying that the first operation in response to the third voice command is related to the first object.

6. The method for controlling a smart device in claim 1, wherein,
the identifier is an ordinal number determined based on a status in which the plurality of objects are arranged.

7. The method for controlling a smart device in claim 1, wherein,
the first contents are provided to be scrolled in at least one direction according to a user command.

8. The method for controlling a smart device in claim 1, wherein,
the second operation includes displaying an area determined to include the first object of the first contents.

9. The method for controlling a smart device in claim 1, wherein,
the second operation includes displaying the first area to display the first object.

10. The method for controlling a smart device in claim 1, wherein,
the second operation includes overlapping a pop-up window including the first object on the second area, while the second area is being displayed.

11. The method for controlling a smart device in claim 1, wherein,
the second operation includes outputting a guide voice requesting confirmation of the first operation related to the first object.

12. The method for controlling a smart device in claim 1, wherein,
the smart device is a smart projector which outputs the display-back by outputting light.

13. The method for controlling a smart device in claim 1, wherein,
the second voice includes the second voice which requests scrolling of the displayed area, and,
the outputting of the display-back displaying the second area further comprises, outputting the display-back displaying the second area which is adjacent to the first area.

14. A smart device configured to obtain a voice command and output various feedbacks corresponding to the voice command, wherein, the feedbacks include a display-back and a talk-back, comprising:
a microphone module configured to obtain the voice command;
a video output module configured to output the display-back;
a speaker module configured to output the talk-back; and
a control unit configured to,
receive a first voice including a first voice command and uttered by a user via the microphone module,
output a display-back displaying a first area including a first group which are a part of a plurality objects of first contents, wherein, the first contents include the plurality of objects and each object included in the plurality of objects includes identifier assigned to the objects respectively, via the video output module,
receive a second voice including a second voice command and uttered by the user via the microphone module, wherein the second voice command requests at least part of objects which are not included in the first group among the first contents,
in response to the second voice command, outputs a display-back displaying a second area including a second group which is at least partially different from the first group and included in the plurality of the objects of the first contents, via the video output module,
receive a third voice including a third voice command uttered by the user, via the video output module, wherein, the third voice command includes a first identifier corresponding to a first object and requests a first operation related to the first object,
perform the first operation, when the first object is included in the second area, and
perform a second operation requesting confirmation of performing of the first operation related to the first object and the first object, to the user, including visual contents, when the first object is not included in the second area.

15. The smart device in claim 14, wherein,
the control unit is configured to, obtain a voice confirming performing the first operation, in response to the second operation, via the microphone module, when the first object is not included in the first area, and perform the first operation.

16. The smart device in claim 14, wherein,
the second operation includes outputting the feedback requesting confirmation of performing the first operation related to the first object and the first identifier.

17. The smart device in claim 14, wherein,
the video output module is one of a projector module which outputs light thereby outputs the display-back or a display module which outputs the display-back through a display.

18. The smart device in claim 14, wherein,
the third voice command is a voice command requesting displaying of second contents related to the first object, and
the first operation including representing the second contents related to the first object.

19. The smart device in claim 14, wherein,
the second operation includes a display-back or a talk back for notifying that the first operation in response to the second voice command is related to the first object.

20. The smart device in claim 14, wherein,
the second operation includes overlapping a pop-up window including the first object on the second area, while the second area is being displayed.

21. The smart device in claim 14, wherein,
the second operation includes outputting a guide voice requesting confirmation of performing the first operation related to the first object.
